(19) United States
(12) Patent Application Publication
(10) Pub. No.: US 2018/0145447 A1
(43) Pub. Date: May 24, 2018

(54) Photovoltaic Electrical Connector

(71) Applicant: Changshou Fulaide Connector Technology Co. Ltd., Suzhou City (CN)

(72) Inventor: Jianming Xu, Suzhou City (CN)

(21) Appl. No.: 15/118,445

(22) PCT Filed: Mar. 31, 2015
(86) PCT No.: PCT/CN2015/075495

§ 371 Date: Aug. 11, 2016

(30) Foreign Application Priority Data
Mar. 26, 2015 (CN) 201510134364.3

(51) Int. Cl. H01R 13/627; H01R 13/405; H01R 13/639; H01R 13/52

(52) U.S. Cl. CPC H01R 13/627; H01R 13/52; H01R 13/639; H01R 13/405

(57) ABSTRACT

A photovoltaic electrical connector comprising a male plug and a female socket, each of the male plug and female socket is provide with a plastic casing and a lead wire with one end provided with a metal terminal. The lead wire and the metal terminal are connected and fixed in the plastic casing by injection molding, as such, avoiding the use of snap fitting which could have insecure connection that results in great danger.

### BACKGROUND OF INVENTION

### 1. Field of the Invention

The present invention is related to the technic field of solar energy photovoltaic components, more specifically, a photovoltaic electrical connector.

### 2. Description of Related Art

For a conventional electrical connector a metal snap is first fitted into a plastic casing and then a crimped metal terminal wire of a metal terminal is inserted into the plastic casing. The terminal wire is then fasten in the plastic casing by a snap fitting on the metal snap and the metal terminal. If this connection is not secured there could result in great danger. In a conventional electrical connector the outlet end of the lead wire is twisted onto a nut and by tightening the nut to achieve waterproof effect. However, if the nut is not properly installed, there result defect in waterproof effect. A Conventional electrical connector has a plastic casing which is prone to crack under extreme external force. In additional, a conventional electrical connector has a metal terminal typically consist of a copper coil that has high electrical resistance which could reduce electricity generating efficiency.

### SUMMARY OF THE INVENTION

The objective of the present invention is to provide a solution to the problems of the insecure snap fitting connection of the metal snap in a connector casing and the metal terminal; the poor waterproof effect of the lead wire and the nut; and the inefficient use of the copper coil in the metal terminal.

In order to achieve the above-mentioned objective, the present invention provides an electrical connector comprising a male and a female socket;

the male plug comprising a first plastic casing, and a first lead wire with one end provided with a metal terminal. The first lead wire with the metal terminal end is inserted into the first plastic casing. More specifically, the first plastic casing is provided with a plunger and snap fitting arms around the plunger; and the metal terminal end of the first lead wire is provided with a jack hole;

the female socket comprising a second plastic casing and a second lead wire with one end provided with a metal terminal. The second lead wire with the metal terminal end is inserted into the second plastic casing. More specifically, one end of the second plastic casing is made to form a plunger socket for receiving the plunger and a snap fitting buckles for receiving the snap fitting arms; the metal terminal of the second lead wire is inserted into the plunger socket; and the terminal end of the metal terminal of the second lead wire is inserted into the jack hole of the metal terminal of the first lead wire;

the metal terminal end of the first lead wire of the male plug is integrated fixed inside the first plastic casing by injection molding; and

the metal terminal end of the second lead wire of the female socket is integrated and fixed inside the second plastic casing by injection molding.

According to the present invention, the first lead wire with the metal terminal end is connected and fixed inside the first plastic casing by injection molding to ensure a sealed connection; the same applies to the second lead wire with the metal terminal end is connected and fixed inside the second plastic casing by injection molding to ensure a sealed connection. In other words, the lead wire (first and second) is connected with the respective metal terminal by injection molding as well. As such, avoiding the use of snap fitting which could have insecure connection that results in great danger.

As a further description of the present invention, when the male plug connects with the female socket, the plunger on the male plug is inserted into the plunger socket on the female socket, at the same time, the metal terminal on the female socket is inserted into the jack hole on the male plug; and at the same time, the snap fitting arms are coupled with the snap fitting buckles to secure the connection of the male plug with the female socket.

As a further description on the first and second lead wire, the non-metal terminal end of the first lead wire is also integrated and fixed inside the first plastic casing by injection molding; the non-metal terminal end of the second lead wire is also integrated and fixed inside the second plastic casing by injection molding. With this design the waterproof ability of the electrical connector is greatly improved.

As a further description on the snap fitting arms and the snap fitting buckles, the snap fitting arms may consist of long strip arm bodies integrated with hook tips. The direction of placement of the long strip arm bodies is the same as the extending direction of the first lead wire; the snap fitting buckles may consist of buckle holes with direction of placement as the same as the extending direction of the second lead wire, and the surface end of the buckle holes is provided with a slot perpendiculars to the extending direction of the second lead wire and the slots run through the buckle holes. When the snap fitting arms couple with the snap fitting buckles the hook tips of the snap fitting arms are inserted into the buckle holes of the snap fitting buckles and expose through the buckle holes in the slots, and the hook tips then hook onto the edge of the buckle holes. With the above-mentioned design, when the snap fitting arms couple with the snap fitting buckles, the hook tip enters the buckle hole causing the long strip arm bodies to bend inwardly and when the hook tips expose through the buckle holes the long strip arm bodies return to their original shape causing the hook tips to hook onto the edge of the buckle holes to secure the connection.

As a further description on the snap fitting arms and the snap fitting buckles, the interior angle of the hook tips is less than 90 degree, the edge of the buckle holes for which the hoop tips hook onto is provided with an inclined plane preventing the hoop tips from loosening.

As a further description on the snap fitting arms and the snap fitting buckles, two snap fitting arms are provided and positioned to the two sides of the plunger in the present invention; accordingly, buckle holes are provided on the snap fitting buckles and positioned to the two sides of the plunger socket. As a preferment, two snap fitting arms are symmetrically positioned to the two sides of the plunger with the back side of the hook tips facing one another.

As a further description of the plunger and the plunger socket, the plunger is provided with an annular slot radially positioned on the plunger. The annular slot is provided with an elastic sealing ring. When the plunger is inserted into the plunger socket, the elastic sealing ring presses against the inner wall of the plunger socket to provide a tight and a sealed connection between the plunger and the plunger socket. With this design, the plunger is securely connected with the plunger socket to prevent any potential displacement.

As a further description on the metal terminal of the first and second lead wire, the jack hole of the metal terminal of the first lead wire is provided with a hollow metal collar. The metal collar is fitted tightly around the inner wall of the jack hole. The metal collar is provided to receive the metal terminal of the second lead wire. The presence of the metal collar can ensure a secure connection between the metal terminal of the first and second lead wire and to prevent any potential displacement or loose connection.

As a further description on the first plastic casing, in addition to the plunger and snap fitting arms, the first plastic casing further comprising a flange displaced perpendicular to the extending direction of the first lead wire, a cylinder body with an axial direction as the same as the extending direction of the first lead wire, and a cone body (the larger end of the cone body is called big end, and the smaller end of the cone body is called small end). The plunger and the snap fitting arms are placed on one side of the flange, and one end of the cylinder body connects with the other side of the flange; the big end of the cone body connects with the other end of the cylinder body; and the cross section of the big end is large than the cross section of the cylinder body. The circumferential surface of the cylinder body is provided with a radial snap ring and the peripheral surface of the cylinder body is provided with an axial snap strip. The first plastic casing is enclosed in a soft plastic sleeve, and the soft plastic sleeve is provided with a cylinder body matching circular hole and a cone body matching cone hole. The inner side wall of the circular hole is provided with a radial snap ring matching radial slot and an axial snap strip matching axial slot. According to the above description, the flange, the radial snap ring and the big end of the cone body are provided for preventing the soft plastic sleeve from sliding axially on the first plastic casing; and the axial snap strip and the axial slot are provided for preventing the soft plastic sleeve from sliding radially on the first plastic casing. The soft plastic sleeve provides added impact protection for the first plastic casing and reduces the risk of damage.

As a further description on the second plastic casing, the second plastic casing further comprising a flange displaced perpendicular to the extending direction of the second lead wire, a cylinder body with an axial direction as the same as the extending direction of the second lead wire, and a cone body (the larger end of the cone body is called big end, and the smaller end of the cone body is called small end). The plunger and the snap fitting buckles are placed on one side of the flange, and one end of the cylinder body connects with the other side of the flange; the big end of the cone body connects with the other end of the cylinder body; and the cross section of the big end is large than the cross section of the cylinder body. The circumferential surface of the cylinder body is provided with a radial snap ring and the peripheral surface of the cylinder body is provided with an axial snap strip. The second plastic casing is enclosed in a soft plastic sleeve, and the soft plastic sleeve is provided with a cylinder body matching circular hole and a cone body matching cone hole. The inner side wall of the circular hole is provided with a radial snap ring matching radial slot and an axial snap strip matching axial slot. According to the above description, the flange, the radial snap ring and the big end of the cone body are provided for preventing the soft plastic sleeve from sliding axially on the second plastic casing; and the axial snap strip and the axial slot are provided for preventing the soft plastic sleeve from sliding radially on the second plastic casing. The soft plastic sleeve provides added impact protection for the second plastic casing and reduces the risk of damage.

As a further description on the metal terminal of the first and second lead wire is in cylindrical shape. The cylindrical shape metal terminal is obtained by pressing process to reduce electrical resistance and increase electricity generating efficiency.

### BRIEF DESCRIPTION OF THE DRAWINGS

FIG. 1 is a structural illustration of the photovoltaic electrical connector of the present invention;

FIG. 2 is a disconnected structural illustration of the male plug and female socket;

FIG. 3 is a structural illustration of the female socket in FIG. 2;

FIG. 4 is a structural illustration of the male plug in FIG. 2;

FIG. 5 is an enlarged view of C section in FIG. 3;

FIG. 6 is an enlarged view of B section in FIG. 4;

FIG. 7 is a reverse disconnected structural illustration of the male plug and the female socket in FIG. 1;

FIG. 8 is a structural illustration of the male plug in FIG. 7; and

FIG. 9 is a structural illustration of the female socket in FIG. 7.

### DETAILED DESCRIPTION OF THE PREFERRED EMBODIMENT

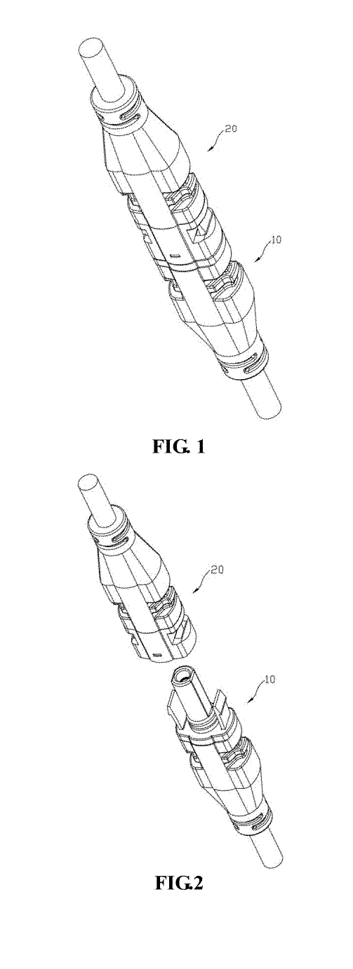

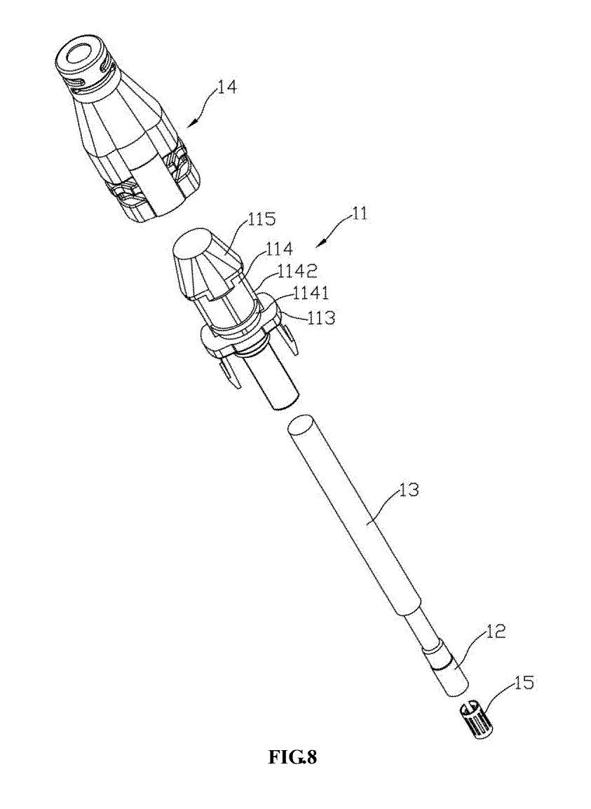

As shown in FIG. 1, FIG. 2 and FIG. 7, a photovoltaic electrical connector comprising a male plug 10 and a female socket 20.

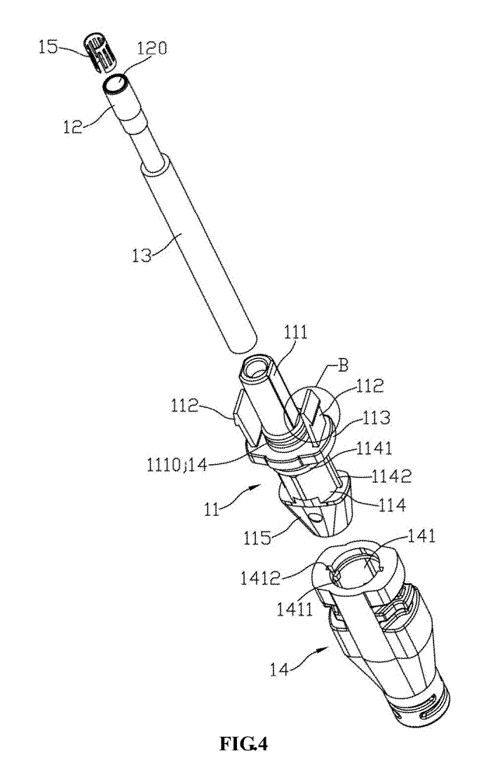

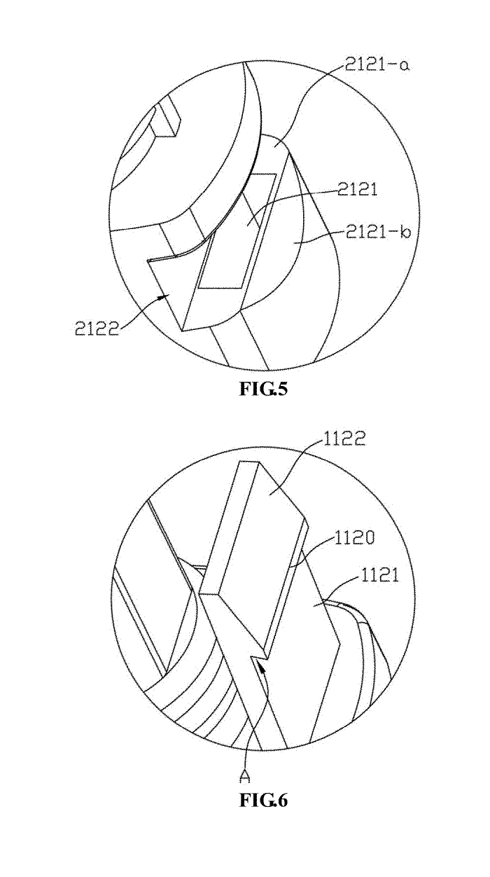

In combination with FIG. 4 and FIG. 8, the male plug 10 comprising a first plastic casing 11 and a first lead wire 13 with one end provided with a metal terminal 12 end. The first lead wire 13 with the metal terminal 12 end is position in the first plastic casing 11. One end of the first plastic casing 11 is provided with a plunger 111 and snap fitting arms 112. More specifically, the metal terminal 12 of the first lead wire 13 is position in the plunger 111; and the surface end of the metal terminal 12 is made to form a jack hole 120. The snap fitting arms 112 are positioned around the side of the plunger 111. Wherein, the metal terminal 12 of the first lead wire 13 is in a cylindrical shape formed and obtained by pressing process; one end of the first lead wire 13 and the metal terminal 12 is fixed and connected in the first plastic casing 11 by injection molding; and the non-metal terminal end of the first lead wire 13 is also fixed and connected in the first plastic casing 11 by injection molding.

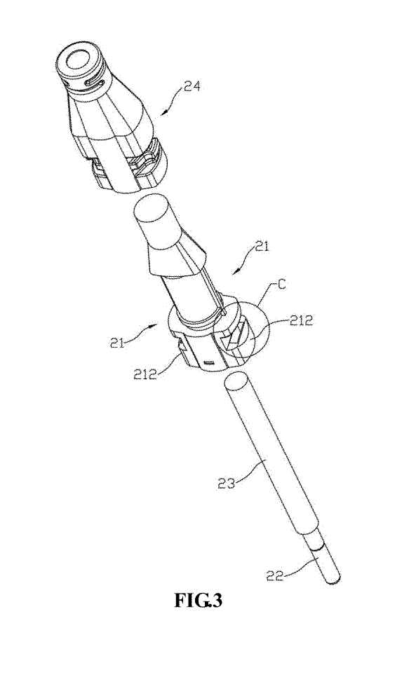

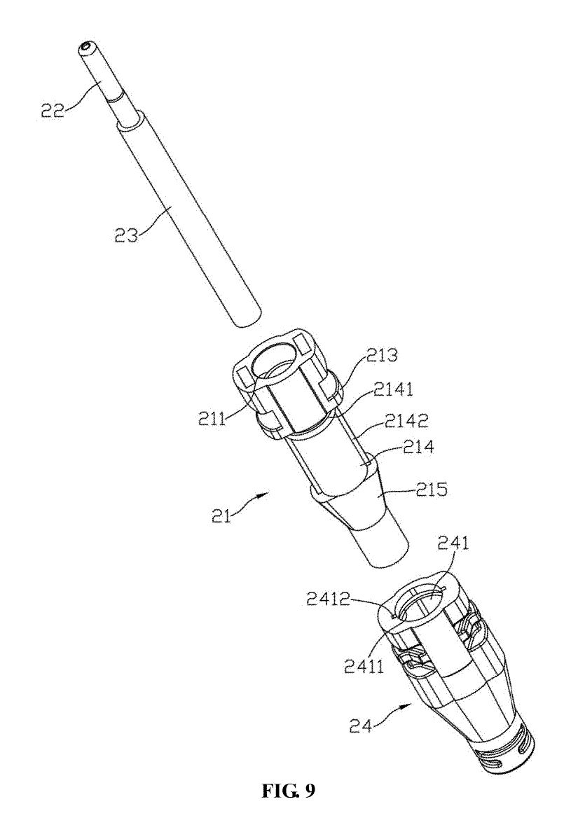

In combination with FIG. 3 and FIG. 9, the female socket 21 comprising a second plastic casing 21 and a second lead wire 23 with one end provided with a metal terminal 22. Wherein, the metal terminal 22 of the second lead wire 23 is positioned in the second plastic casing 21. One end of the second plastic casing is made to form a plunger hole 211 for receiving the plunger 111 and snap fitting buckles 212 for receiving the snap fitting arms 112. More specifically, the metal terminal 22 of the second lead wire 23 is positioned in the plunger hole 211; one end of the metal terminal 22 couples with the jack hole 120 of the metal terminal 12 of the first lead wire 13; and the snap fitting buckles 212 are positioned to the sides of the. Wherein, the metal terminal 22 of the second lead wire 23 is in a cylindrical shape formed and obtained by pressing process; one end of the second lead wire 23 and the metal terminal 22 is fixed and connected in the second plastic casing 21 by injection molding; and the non-metal terminal end of the second lead wire 23 is also fixed and connected in the second plastic casing 21 by injection molding.

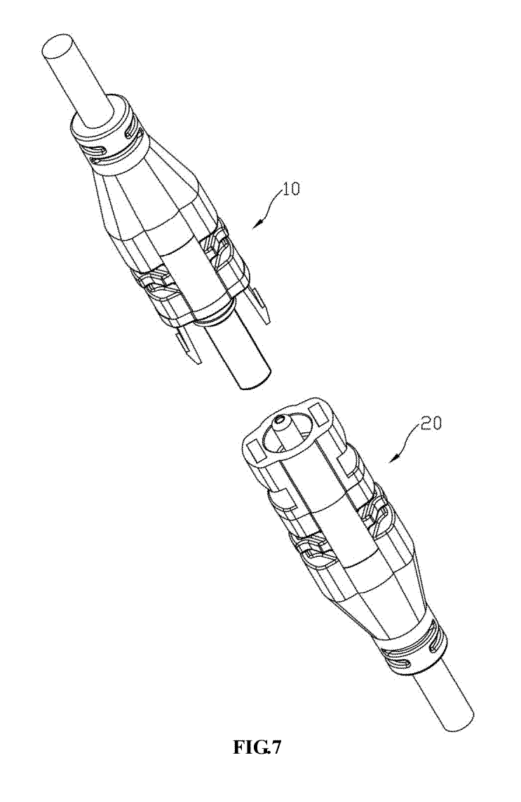

In combination with FIG. 4 and FIG. 6 in the male plug 10, the snap fitting arms 112 comprising long strip arm bodies 1121 with hook tips 1122 together long strip arm bodies 1121 and hook tips 1122 form hook sections 1120. The extending direction of the long strip arm bodies 1121 is the same as the extending direction of the first lead wire 13. In combination with FIG. 3 and FIG. 5 in the female socket 20, the snap fitting buckles 212 comprising buckle holes 2121 with an extending direction as the same as the extending direction of the second lead wire 23. The extending ends of buckle holes 2121 are provided with slots 2122, perpendicular to the extending directions of the second lead wire 23; and the buckles holes 2121 connect with the slots 2122. The number of snap fitting arms on the male plug 10 is two and the two snap fitting arms are positioned to the two sides of the plunger 111; accordingly, to the two sides of the plunger hole 212 on the female socket 20 the snap fitting buckles 212 are positioned for receiving the snap fitting arms 112. When the snap fitting buckles 212 receives the snap fitting arms 112, the long strip arm bodies 1121 are inserted into the buckle holes 2121, the hook tips 1121 then exposed in the slots 2122 through the buckle holes 2121, and then the hook tips 1121 hook onto surface planes 2121-a provided on the surface ends of the slots 2122. In combination with FIG. 5 and FIG. 6 the interior angles A of the hook sections 1120 are smaller than 90 degree, and the surface planes 2121-a are provided with inclined planes 2121-b are the hook tips 1121 rest on.

In combination with FIG. 4 and FIG. 8 in the male plug 10, the plunger 111 is provided with a radially arranged annular slot 1110, an elastic sealing ring 16 is provided in the annular slot 1110. When the plunger 111 connects with the plunger socket 211, the sealing ring 16 presses against the inner wall of the plunger socket to provide a tight and a sealed connection between the plunger 111 and the plunger socket 211.

In combination with FIG. 4 and FIG. 8 in the male plug 10, the first plastic casing 11 comprising a flange 113 displaced perpendicular to the extending direction of the first lead wire 13, a cylinder body 114 with an axial direction as the same as the extending direction of the first lead wire 13, and a cone body 115. The plunger 111 and the snap fitting arms 11 are positioned on one side of the flange 113, and one surface end of the cylinder body 114 is connected with the other side of the flange 113, the big end of the cone body 115 is connected with the other surface end of the cylinder body 114, and the cross section of the big end of the cone body 115 is large than the cross section of the cylinder body 114. The circumferential surface of the cylinder body 114 is provided with a radial snap ring 1141 and the peripheral surface of the cylinder body is provided with an axial snap strip 1142. The first plastic casing 11 is enclosed in a soft plastic sleeve 14, and the soft plastic sleeve 14 is provided with a cylinder body 114 matching circular hole 141 and a cone body matching cone hole. The inner side wall of the circular hole 141 is provided with a radial snap ring 1141 matching radial slot 1411 and an axial snap strip 1142 matching axial slot 1412.

In combination with FIG. 3 and FIG. 9 in the female socket 20, the second plastic casing 21 further comprising a flange 213 displaced perpendicular to the extending direction of the second lead wire 23, a cylinder body 214 with an axial direction as the same as the extending direction of the second lead wire, and a cone body 215. The plunger 211 and the snap fitting buckles 212 are placed on one side of the flange 213, and one end of the cylinder body 214 is connected with the other side of the flange 213; the big end of the cone body 214 is connected with the other end of the cylinder body 214; and the cross section of the big end of the cone body 215 is large than the cross section of the cylinder body 215. The circumferential surface of the cylinder body 214 is provided with a radial snap ring 2141 and the peripheral surface of the cylinder body 214 is provided with an axial snap strip 2142. The second plastic casing 21 is enclosed in a soft plastic sleeve 24, and the soft plastic sleeve 24 is provided with a cylinder body 214 matching circular hole 241 and a cone body 215 matching cone hole. The inner side wall of the circular hole 241 is provided with a radial snap ring 2141 matching radial slot 2411 and an axial snap strip 2142 matching axial slot 2412.

Although the invention has been explained in relation to its preferred embodiment, it is to be understood that many other possible modifications and variations can be made without departing from the spirit and scope of the invention as hereinafter claimed.

1. A photovoltaic electrical connector comprising a male plug and a female socket; said male plug comprising a first plastic casing, a first lead wire with one end provided with a metal terminal; wherein, the metal terminal of the first lead wire is positioned in the first plastic casing; one end of the said first plastic casing is provided with a plunger and snap fitting arms; the metal terminal of the first lead wire is positioned in the said plunger of the first plastic casing; one surface end of the said metal terminal is provided with a jack hole; said snap fitting arms are positioned to the two sides of the said plunger; said female socket comprising a second plastic casing, and a second lead wire with one end provided with a metal terminal; the metal terminal of the second lead wire is positioned in the said second plastic casing; one end of the said second plastic casing is provided a plunger socket for receiving the plunger and snap fitting buckles for receiving the snap fitting arms; the metal terminal of the second lead wire is positioned in plunger socket; one end of the metal terminal of the second lead wire connects with the jack hole of the metal terminal of the first lead wire; said snap fitting buckles are position to the two sides of the said plunger socket; it is characterized that: the first lead wire with the metal terminal end is fixed and connected in the first plastic casing by injection molding; and the second lead wire with the metal terminal end is fixed and connected in the second plastic casing by injection molding.

2. The photovoltaic electrical connector as claimed in claim 1, wherein it is characterized that: the first lead wire with non-metal terminal end is also fixed and connected in the first plastic casing by injection molding; and the second lead wire with non-metal terminal end is also fixed and connected in the second plastic casing by injection molding.

3. The photovoltaic electrical connector as claimed in claim 1, wherein it is characterized that: said snap fitting arms comprising long strip arm bodies, and hook tips on the top end of the long strip arm bodies, said long strip arm bodies and hook tip are integrated to form hook section, and the extending direction of the long strip arm bodies is the same as the extending direction of the first lead wire; said snap fitting buckles comprising buckle holes with extending direction the same as the extending direction of the second lead wire, one end of the buckle holes are provided with slots perpendicular to the extending direction of the second lead wire, said slots connect with the buckle holes; the snap fitting arms couple with the snap fitting buckles, the hook tip enters the buckle hole expose in the slots through the buckle holes, the hook tips then hook onto the edge of the buckle holes.

4. The photovoltaic electrical connector as claimed in claim 3, wherein the interior angle of the hook tips is less than 90 degree, the edge of the buckle holes for which the hoop tips hook onto is provided with an inclined plane, and the hook tips hook onto the said inclined plane.

5. The photovoltaic electrical connector as claimed in claim 3, wherein two snap fitting arms are provided and positioned to the two sides of the said plunger; and as accordingly, buckle holes are provided on the snap fitting buckles and positioned to the two sides of the plunger socket for receiving the two snap fitting arms.

6. The photovoltaic electrical connector as claimed in claim 3, wherein the plunger is provided with a radially arranged annular slot, an elastic sealing ring is provided in the said annular slot; when the plunger connects with the plunger socket, the sealing ring presses against the inner wall of the plunger socket to provide a tight and a sealed connection between the plunger and the plunger socket.

7. The photovoltaic electrical connector as claimed in claim 1, wherein the jack hole of the metal terminal of the first lead wire is provided with a hollow metal collar; the metal collar is fitted tightly around the inner wall of the jack hole; and the metal collar is provided to receive the metal terminal of the second lead wire.

8. The photovoltaic electrical connector as claimed in claim 1, wherein it is characterized that: the first plastic casing comprising a flange displaced perpendicular to the extending direction of the first lead wire, a cylinder body with an axial direction as the same as the extending direction of the first lead wire, and a cone body; said plunger and snap fitting arms are positioned on one side of the flange, and one surface end of the cylinder body is connected with the other side of the flange, the big end of the cone body is connected with the other surface end of the cylinder body, and the cross section of the big end of the cone body is large than the cross section of the cylinder body; the circumferential surface of the said cylinder body is provided with a radial snap ring and the peripheral surface of the cylinder body is provided with an axial snap strip; the first plastic casing is enclosed in a soft plastic sleeve, and the soft plastic sleeve is provided with a cylinder body matching circular hole and a cone body matching cone hole; and the inner side wall of the circular hole is provided with a radial snap ring matching radial slot and an axial snap strip matching axial slot.

9. The photovoltaic electrical connector as claimed in claim 1, wherein the second plastic casing further comprising a flange displaced perpendicular to the extending direction of the second lead wire, a cylinder body with an axial direction as the same as the extending direction of the second lead wire, and a cone body; the plunger and the snap fitting buckles are placed on one side of the flange and one end of the cylinder body is connected with the other side of the flange; the big end of the cone body is connected with the other end of the cylinder body; and the cross section of the big end of the cone body is large than the cross section of the cylinder body; the circumferential surface of the cylinder body is provided with a radial snap ring and the peripheral surface of the cylinder body is provided with an axial snap strip; the second plastic casing is enclosed in a soft plastic sleeve, and the soft plastic sleeve is provided with a cylinder body matching circular hole and a cone body matching cone hole and the inner side wall of the circular hole is provided with a radial snap ring matching radial slot and an axial snap strip matching axial slot.

10. The photovoltaic electrical connector as claimed in claim 1, wherein it is characterized that: said metal terminal of the first and second lead wire is in cylindrical shape and said cylindrical shaped metal terminal is form and obtained by pressing process
